(19) United States
(12) Patent Application Publication
(10) Pub. No.: US 2015/0022946 A1
(43) Pub. Date: Jan. 22, 2015

(54) MULTILAYER CERAMIC CAPACITOR AND METHOD OF MANUFACTURING THE SAME

(71) Applicant: Samsung Electro-Mechanics Co., Ltd., Suwon (KR)

(72) Inventors: Heung Kil PARK, Suwon (KR); Min Cheol Park, Suwon (KR)

(73) Assignee: SAMSUNG ELECTRO-MECHANICS CO., LTD., Suwon (KR)

(21) Appl. No.: 14/147,378

(22) Filed: Jan. 3, 2014

(30) Foreign Application Priority Data
Jul. 22, 2013 (KR) 10-2013-0086101

(51) Int. Cl. H01G 4/30

(52) U.S. Cl. CPC H01G 4/30
USPC 361/301.4

(57) ABSTRACT

There is provided a multilayer ceramic capacitor including: a ceramic body including a plurality of dielectric layers laminated in a width direction, first and second external electrodes formed on the first main surface of the ceramic body to be spaced apart from each other, third and fourth external electrodes formed on the second main surface of the ceramic body to be spaced apart from each other, a capacitor unit including a plurality of first and second internal electrodes disposed to face each other with the dielectric layers interposed therebetween within the ceramic body and electrically connected to the first to fourth external electrodes, and at least one equivalent serial resistance (ESR) control layer interposed within the ceramic body to be perpendicular to the mounting surface.

### CROSS-REFERENCE TO RELATED APPLICATION

This application claims the benefit of Korean Patent Application No. 10-2013-0086101 filed on Jul. 22, 2013, with the Korean Intellectual Property Office, the disclosure of which is incorporated herein by reference.

### BACKGROUND

The present disclosure relates to a multilayer ceramic capacitor and a method of manufacturing the same.

A multilayer ceramic capacitor (MLCC), a multilayer chip electronic component, may be used in various electronic devices, due to advantages such as compactness, high capacitance, and ease of mountability.

For example, the multilayer ceramic capacitor is used in a chip-shaped condenser mounted on printed circuit boards of various electronic products including display devices such as liquid crystal displays (LCDs), plasma display panels (PDPs) and the like, as well as including computers, personal digital assistants (PDAs), mobile phones, and the like, to serve to charge and discharge electricity therein.

In particular, in a power supply device for a central processing unit (CPU) such as a computer, or the like, voltage noise may be generated due to rapid changes in a level of a load current during a process of providing low level voltage.

Thus, a multilayer capacitor is commonly used as a decoupling capacitor in a power supply device in order to restrain voltage noise.

A decoupling multilayer ceramic capacitor is required to have a low ESL value as an operational frequency is increased, and research into reduction in ESL has been actively conducted.

In addition, in order to supply power more stably, a decoupling multilayer ceramic capacitor is required to have adjustable ESR characteristics.

If an ESR value of a multilayer ceramic capacitor is lower than a required level, an impedance peak in a parallel resonance frequency is increased and impedance in a serial resonance frequency is excessively lowered due to ESL of the capacitor and plane capacitance of a microprocessor package.

Therefore, ESR characteristics of the decoupling multilayer ceramic capacitor may be easily controlled and improved, such that flat impedance characteristics in a power distribution network may be implemented by a user.

In connection with the controlling of ESR, a method of forming an external electrode and an internal electrode with a material having high electrical resistance may be considered. Using a material having high electrical resistance may be advantageous, in that high ESR characteristics are provided while a low ESL structure is maintained, as in the case of the related art.

However, the use of a high resistance material to form an external electrode generates a localized heat spot, causing current concentration due to a pin hole.

In addition, in the case of using a material having a high degree of electrical resistance for an internal electrode, an internal electrode material needs to be continuously changed so as to match a ceramic material according to high capacitance.

Therefore, since the method of controlling ESR according to the related art has disadvantages as described above, research into a multilayer ceramic capacitor allowing for control of ESR remains necessary.

Meanwhile, with a rapid development of a mobile terminal such as a tablet PC, an ultrabook, or the like, in recent years, a micro processor has been converted to a high-integration product having a small size.

Therefore, since an area of a printed circuit board is decreased and a space for mounting a decoupling capacitor therein is limited, a multilayer ceramic capacitor capable of overcoming the disadvantages has been demanded.

Patent document 1 discloses an MLCC but without a structure for controlling ESR.

### RELATED ART DOCUMENT

(Patent Document 1) Korean Patent Laid-Open Publication No. 10-2009-0026174

### SUMMARY

An aspect of the present disclosure may provide a method for effectively controlling equivalent serial resistance (ESR) of a multilayer ceramic capacitor.

According to an aspect of the present disclosure, a multilayer ceramic capacitor may include: a ceramic body including a plurality of dielectric layers laminated in a width direction to be perpendicular to a mounting surface and having first and second main surfaces facing each other in a thickness direction, third and fourth end surfaces facing each other in a length direction, and fifth and sixth side surfaces facing each other in the width direction; first and second external electrodes formed on the first main surface of the ceramic body to be spaced apart from each other; third and fourth external electrodes formed on the second main surface of the ceramic body to be spaced apart from each other; a capacitor unit including a plurality of first and second internal electrodes disposed to face each other with the dielectric layers interposed therebetween within the ceramic body and electrically connected to the first to fourth external electrodes; and at least one equivalent serial resistance (ESR) control layer interposed within the ceramic body to be perpendicular to the mounting surface.

The first internal electrodes may be exposed to the first main surface to be electrically connected to the first external electrode.

The second internal electrodes may be exposed to the second main surface to be electrically connected to the fourth external electrode.

The at least one ESR control layer may have first and second internal connection conductors connecting the first and third external electrodes and the second and fourth external electrodes, respectively.

The mounting surface of the multilayer ceramic capacitor may be the second main surface of the ceramic body.

The first and second internal connection conductors may be formed to have a linear shape.

According to another aspect of the present disclosure, a multilayer ceramic capacitor may include: a ceramic body including a plurality of dielectric layers laminated in a width direction to be perpendicular to amounting surface and having first and second main surfaces facing each other in a thickness direction, third and fourth end surfaces facing each other in a length direction, and fifth and sixth side surfaces facing each other in the width direction, first and second external electrodes formed on the first main surface of the ceramic body to be spaced apart from each other, third and fourth external electrodes formed on the second main surface of the ceramic body to be spaced apart from each other, a capacitor unit including a plurality of first and second internal electrodes disposed to face each other with the dielectric layers interposed therebetween within the ceramic body and exposed to the first and second main surfaces so as to be electrically connected to the second and fourth external electrodes, respectively, and at least one equivalent serial resistance (ESR) control layer interposed within the ceramic body in the width direction and having first and second internal connection conductors connecting the second and third external electrodes and the first and fourth external electrodes, respectively.

The first internal connection conductor may be formed in the length and thickness directions of the ceramic body, and the second internal connection conductor may be formed in the length and thickness directions of the ceramic body.

The first and second internal connection conductors may be formed in a non-linear manner, vertically, in the length direction of the ceramic body.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a multilayer ceramic capacitor (MLCC) according to an exemplary embodiment of the present disclosure;

FIGS. 2A through 2C are plan views illustrating first and second internal electrodes and first and second internal connection conductors applied to the MLCC of FIG. 1;

FIG. 3 is an equivalent circuit diagram of the MLCC of FIG. 1;

FIG. 4 is a perspective view illustrating a state in which an MLCC is applied to a mounting board according to an exemplary embodiment of the present disclosure;

FIG. 5 is a perspective view schematically illustrating mutual inductance of the mounting board having the MLCC of FIG. 4 mounted thereon;

FIGS. 6A through 6F are plan views illustrating a layout structure of the first and second internal electrodes and the first and second internal connection conductors applied to an MLCC according to another exemplary embodiment of the present disclosure;

FIGS. 7A through 7D are plan views illustrating a layout structure of the first and second internal electrodes and the first and second internal connection conductors applied to an MLCC according to another exemplary embodiment of the present disclosure;

FIGS. 8A and 8B are plan views illustrating a layout structure of the first and second internal connection conductors applied to the MLCC according to another exemplary embodiment of the present disclosure; and

FIG. 9 is an equivalent circuit diagram of the MLCC according to another exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

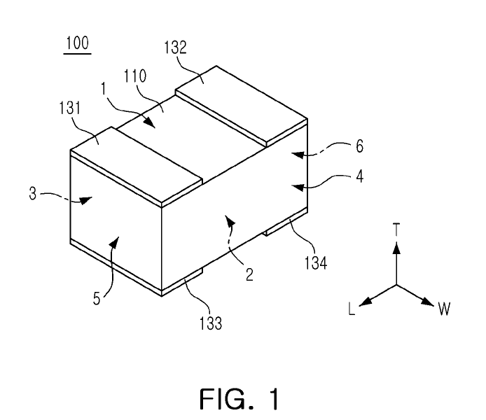

In order to clarify exemplary embodiments of the present disclosure, directions of a hexahedron may be defined as follows. L, W, and T indicated in FIG. 1 denote a length direction, a width direction, and a thickness direction, respectively.

Multilayer Ceramic Capacitor (MLCC)

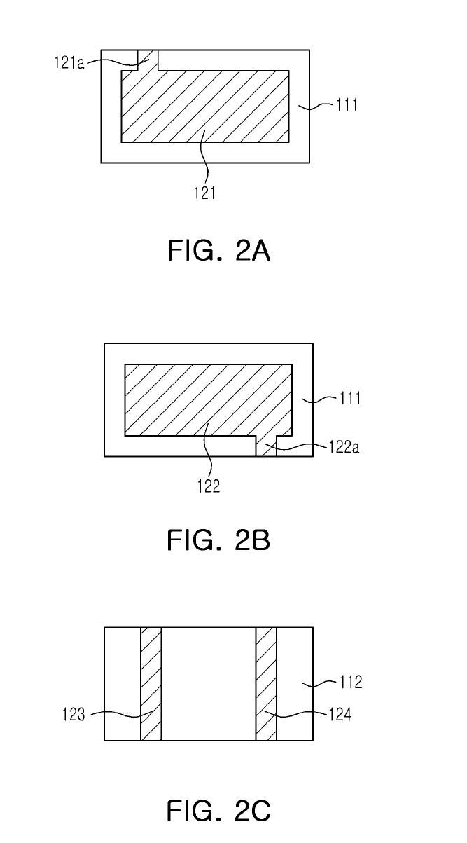

FIG. 1 is a perspective view schematically illustrating a multilayer ceramic capacitor (MLCC) according to an exemplary embodiment of the present disclosure, and FIGS. 2A through 2C are plan views illustrating first and second internal electrodes and first and second internal connection conductors applied to the MLCC of FIG. 1.

An MLCC 100 according to the present exemplary embodiment may include a ceramic body 110 having a plurality of dielectric layers 111 laminated in a width direction, first to fourth external electrodes 131, 132, 133, and 134, a capacitor unit including a plurality of first and second internal electrodes 121 and 122, and at least one equivalent series resistance (ESR) control layer. Here, the ESR control layer may have a pair of first and second internal connection conductors 123 and 124. Namely, the MLCC 100 according to the present exemplary embodiment may be a 4-terminal capacitor having a total of four external electrodes.

Referring to FIG. 1, the ceramic body 110 is formed by laminating a plurality of dielectric layers 111 and subsequently sintering the same, and adjacent dielectric layers 111 may be integrated such that boundaries therebetween may not be readily apparent.

Also, the ceramic body 110 may have a hexahedral shape. In the present exemplary embodiment, surfaces of the ceramic body 110 facing each other in the thickness direction will be defined as first and second main surfaces 1 and 2, end surfaces connecting the first and second main surfaces 1 and 2 and facing each other in the length direction will be defined as third and fourth end surfaces 3 and 4, and surfaces facing each other in the width direction will be defined as fifth and sixth side surfaces 5 and 6.

The dielectric layer 111 may be made of a ceramic material having high dielectric constant (or high K-dielectrics), e.g., a barium titanate (BaTiO₃)-based ceramic powder, or the like, but the present inventive concept is not limited thereto and any material may be used as long as it can obtain sufficient capacitance.

Also, the dielectric layer 111 may further include various ceramic additives, an organic solvent, a plasticizer, a bonder, a dispersing agent, and the like, such as a transition metal oxide or carbide, a rare earth element, magnesium (Mg), aluminum (Al), or the like, as necessary, together with the ceramic powder.

Referring to FIGS. 2A and 2B, the first and second internal electrodes 121 and 122 constituting the capacitor unit have different polarities, are formed and laminated at least one surface of a ceramic sheet forming the dielectric layer 111, and have first and second lead portions 121a and 122a alternately exposed to the first and second main surfaces 1 and 2 with the dielectric layer 111 interposed therebetween in the thickness direction within the ceramic body 100. The first and second lead portions 121a and 122a may be formed to be opposite to each other in a diagonal direction.

Here, the first and second internal electrodes 121 and 122 are electrically insulated from each other by the dielectric layer 111 interposed therebetween and capacitance of the MLCC 100 may be in proportion to an area of the first and second internal electrodes 121 and 122 that overlap in the lamination direction of the dielectric layer 111, excluding the first and second lead portions 121a and 122a, in the capacitor unit.

Also, the first and second internal electrodes 121 and 122 may be formed of a conductive metal. For example, one of silver (Ag), palladium (Pd), platinum (Pt), nickel (Ni), and copper (Cu), or an alloy thereof, and the like, may be used, but the present inventive concept is not limited thereto.

Referring to FIG. 2C, at least one or more ESR control layer is interposed in the width direction within the ceramic body 110 to control ESR of the MLCC 100.

The ESR control layer may include the first internal connection conductor 123 having both ends exposed to the first and second main surfaces 1 and 2 to connect the first and third external electrodes 131 and 133 to at least one surface of a dielectric layer 112 and the second internal connection conductor 124 having both ends exposed to the first and second main surfaces 1 and 2 to connect the second and fourth external electrodes 132 and 134 to at least one surface of the dielectric layer 112.

Here, the first and second internal connection conductors 123 and 124 may have a linear shape connecting the first and second main surfaces 1 and 2 of the dielectric layer 112, but the present inventive concept is not limited thereto.

Also, the first and second internal connection conductors 123 and 124 may be formed of a conductive metal. For example, one of silver (Ag), palladium (Pd), platinum (Pt), nickel (Ni), and copper (Cu), or an alloy thereof, and the like, may be used, but the present inventive concept is not limited thereto.

The first and second external electrodes 131 and 132 may be formed to be spaced apart from each other on the first main surface 1 of the ceramic body 110, and the third and fourth external electrodes 133 and 134 are formed to be spaced apart from each other on the second main surface 2 of the ceramic body 110.

Here, an upper end portion of the first internal connection conductor 123 exposed to the first lead portion 121a of the first internal electrode 121 and the first main surface 1 may be connected to the first external electrode 131, and an upper portion of the second internal connection conductor 124 exposed to the first main surface 1 may be connected to the second external electrode 132.

A lower end portion of the first internal connection conductor 123 exposed to the second main surface 2 may be connected to the third external electrode 133, and a lower end portion of the second internal connection conductor 124 exposed to the second lead portion 122a of the second internal electrode 122 and the second main surface 2 may be connected to the fourth external electrode 134.

The first to fourth external electrodes 131, 132, 133, and 134 may be formed of a conductive paste including a conductive metal.

The conductive metal may be nickel (Ni), copper (Cu), tin (Sn), or an alloy thereof, but the present inventive concept is not limited thereto.

The conductive paste may further include an insulating material, and the insulating material may be glass, for example, but the present inventive concept is not limited thereto.

Here, a method for forming the first to fourth external electrodes 131, 132, 133, and 134 is not particularly limited and may be formed by dipping the ceramic body 110 and, if necessary, any other method such as plating, or the like, may be used.

Meanwhile, according to the present exemplary embodiment, a mounting surface of the MLCC 100 may be the second main surface 2 of the ceramic body 110.

The MLCC 100 according to the present exemplary embodiment may be mounted on a board to be perpendicular thereto, but the present inventive concept is not limited thereto and, if necessary, the MLCC 100 may be mounted in various forms.

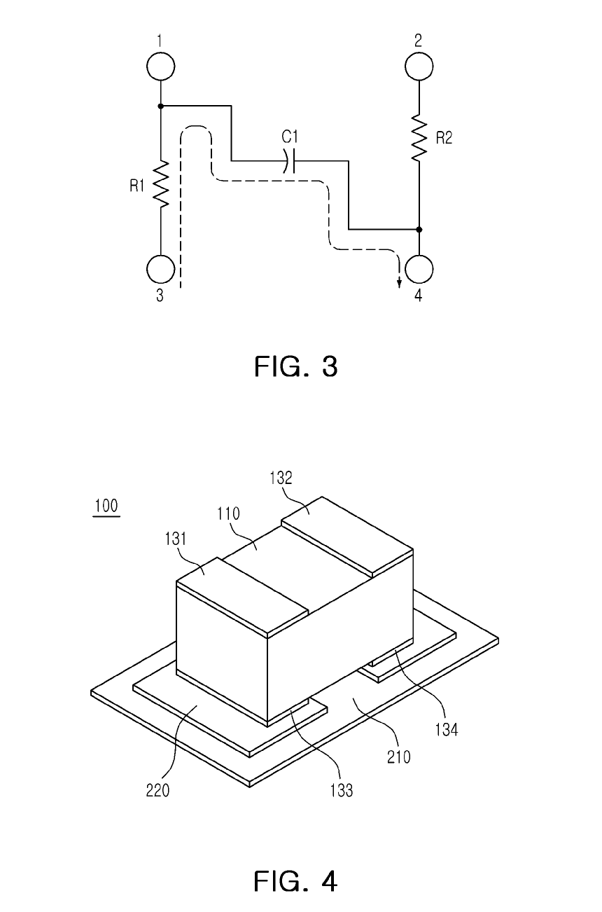

FIG. 3 is an equivalent circuit diagram of the MLCC of FIG. 1.

Referring to FIG. 3, the first and second internal electrodes 121 and 122 constituting the capacitor unit may be connected in parallel to each other by the first to fourth external electrodes 131, 132, 133, and 134, and may be connected in series to the first and second internal connection conductors 123 and 124 constituting the ESR layer.

Through the foregoing connections, ESR of the MLCC 100 may be controlled by the first and second internal connection conductors 123 and 124.

Meanwhile, according to the present exemplary embodiment, the third and fourth external electrodes 133 and 134 formed on the second main surface 2 of the ceramic body 110 may be used as external terminals for connection to a power source line, and the external electrodes 131 and 132 formed on the first main surface 1 of the ceramic body 110 may be used as external electrodes for controlling ESR.

The first and second external electrodes 131 and 132 that may be used as external electrodes for controlling ESR are non-contact terminals not connected to the power source line as mentioned above, and when viewed in a mounted state, the first and second external electrodes 131 and 132 may be positioned on an upper surface, i.e., on the first main surface 1, of the MLCC 100.

Namely, since the first and second external electrodes 131 and 132 as non-contact terminals are formed on the upper surface, i.e., the first main surface 1, facing the mounting surface, rather than being formed on the side surface of the MLCC 100, the downsizing of the non-contact terminals may not be hindered, which may be advantageous for reducing a size of a product, allow for high density mounting, and prevent defective mounting such as a solder bridge, or the like.

Meanwhile, first and second plated layers (not shown) may be formed on the third and fourth external electrodes 133 and 134.

The first and second plated layers may include a nickel (Ni) plated layer formed on the third and fourth external electrodes 133 and 134 and a tin (Sn) plated layer formed on the nickel plated layer.

The first and second plated layers serve to increase bonding strength when the MLCC 100 is mounted on a printed circuit board (PCB), or the like, with solder, and here, plating may be performed through a known method. Preferably, lead-free plating may be performed in terms of environmentally-friendly aspect, but the present inventive concept is not limited thereto.

Method for Manufacturing MLCC

Hereinafter, a method for manufacturing an MLCC according to an exemplary embodiment of the present disclosure will be described.

First, a plurality of ceramic sheets are prepared. The ceramic sheets forming the dielectric layers 111 and 112 of the ceramic body 110, may be fabricated as sheets each having a thickness of several micrometers (μm) by mixing a ceramic powder, a polymer, and a solvent to prepare slurry, applying the slurry to carrier films through a doctor blade method, or the like, and drying the same.

Next, a conductive paste is printed to have a predetermined thickness on at least one surface of each of the plurality of ceramic sheets to form the first and second internal electrodes 121 and 122.

Here, the first and second internal electrodes 121 and 122 may be formed to be exposed to the left and right surfaces of the ceramic sheets.

Also, as a printing method of the conductive paste, a screen printing method, a gravure printing method, or the like, may be used, but the present inventive concept is not limited thereto.

A conductive paste may be printed to have a predetermined thickness on at least one surface of some ceramic sheets to form the first and second internal connection conductors 123 and 124 such that the first and second internal connection conductors 123 and 124 are spaced apart from each other by a predetermined interval, parallel to each other, and exposed to the left and right side surfaces, to form the ESR control layer.

Here, the first and second internal connection conductors 123 and 124 may be disposed to face each other in the length direction of the ceramic sheet, and may each have a linear shape. Also, the first and second internal connection conductors 123 and 124 may be disposed to face each other in the length direction of the ceramic sheet, and may be formed in a non-linear manner, to the left and to the right.

Thereafter, the plurality of ceramic sheets with the first and second internal electrodes 121 and 122 formed thereon are laminated in the width direction while having at least one ceramic sheet with the first and second internal connection conductors 123 and 124 formed thereon, interposed therebetween, and then are pressurized in an inward direction to prepare a laminate body.

Thereafter, the laminate body is cut in every region corresponding to a single capacitor to forma chip, and the chip is sintered at a high temperature to prepare the ceramic body 110 having the first and second main surfaces 1 and 2 facing each other in the thickness direction in which the first and second internal electrodes 121 and 122 are alternately exposed, the third and fourth end surfaces 3 and 4 facing each other in the length direction, and the fifth and sixth side surfaces 5 and 6 facing each other in the width direction.

Thereafter, the first external electrode 131 is formed on the first main surface 1 of the ceramic body 110 so as to be in contact with and electrically connected to an exposed portion of the first internal electrode 121, and the second external electrode 132 is formed to be spaced apart from the first external electrode 131 so as to be in contact with and electrically connected to an upwardly exposed portion of the second internal connection conductor 124.

Here, if necessary, after the operation of forming the first and second external electrodes 131 and 132, surfaces of the first and second external electrodes 131 and 132 may be plated through a method such as electroplating, or the like, to form first and second plated layers (not shown).

Thereafter, the fourth external electrode may be formed on the second main surface 2 of the ceramic body 110 in such a manner that it is in contact with and electrically connected to downwardly exposed portions of the second internal electrode 122 and the second internal connection conductor 124, and the third external electrode 133 may be formed to be spaced apart from the fourth external electrode 134 in such a manner that it is in contact with and electrically connected to a downwardly exposed portion of the first internal connection conductor 123, thereby completing an MLCC.

In this case, if necessary, after the operation of forming the third and fourth external electrodes 133 and 134, surfaces of the first and second external electrodes 133 and 134 may be plated through a method such as electroplating, or the like, to form first and second plated layers (not shown).

FIG. 4 is a perspective view illustrating a state in which an MLCC is applied to a mounting board according to an exemplary embodiment of the present disclosure.

Referring to FIG. 4, the mounting board to which the MLCC 100 is applied may include a PCB 210 having the MLCC 100 mounted thereon and first and second electrode pads 220 formed on an upper surface of the PCB 210 to be spaced apart from each other.

Here, the MLCC 100 may be mounted such that the second main surface of the ceramic body 110 faces the PCB 210, and may be electrically connected to the PCB 210 by solder (not shown) in a state in which the third and fourth external electrodes 133 and 134 are positioned to be in contact with the first and second electrode pads 220.

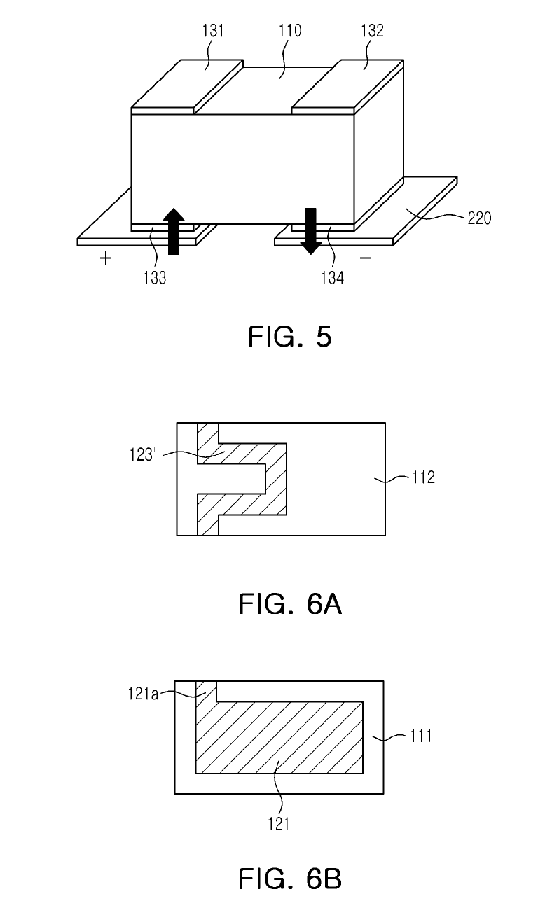

Also, referring to FIG. 5, as indicated by the arrows, the mounting board to which the MLCC is applied may prevent an increase in ESL due to mutual inductance (trade-off of magnetic flux) produced between the internal connection conductors of the ESR control layer.

### Modified Example

The first and second internal connection conductors according to an exemplary embodiment may have various pattern shapes, and ESR characteristics may be more precisely controlled according to pattern shapes.

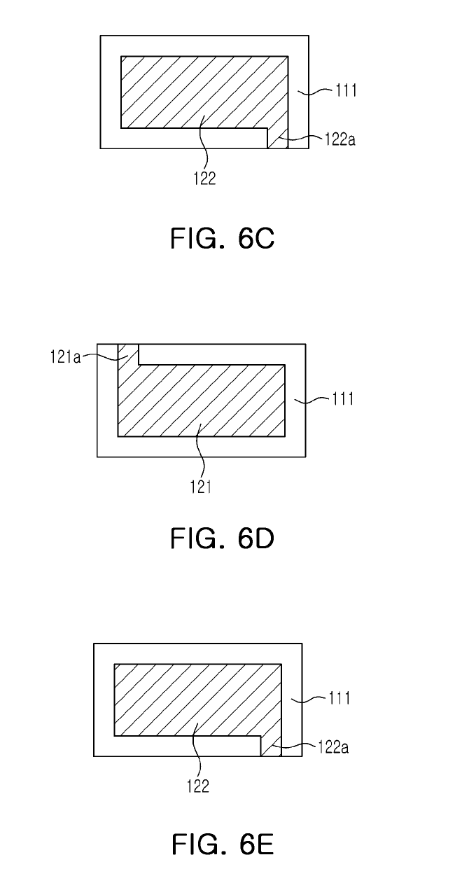

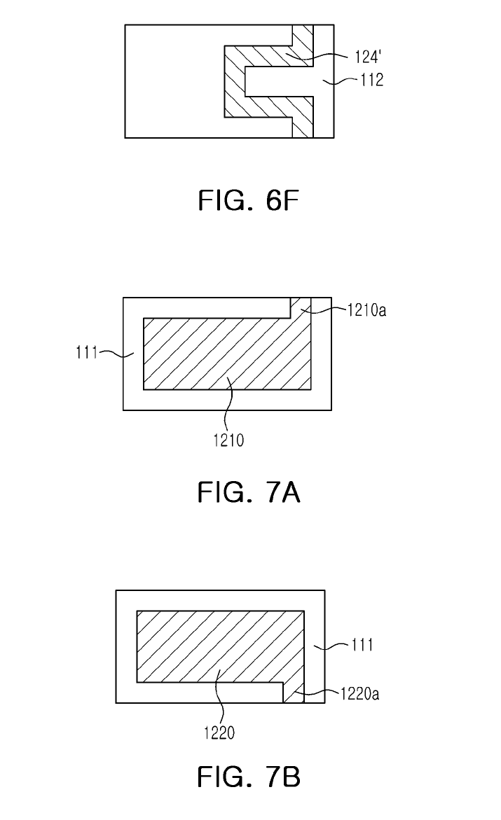

FIGS. 6A through 6F are plan views illustrating a layout structure of the first and second internal electrodes and the first and second internal connection conductors applied to an MLCC according to another exemplary embodiment of the present disclosure.

Here, the structure in which the ceramic body 110, the first and second internal electrodes 121 and 122 and the first to fourth external electrodes 131, 132, 133, and 134 are formed is identical to that of the exemplary embodiment as described above, so a detailed description thereof will be omitted to avoid repetition, and first and second internal connection conductors 123′ and 124′ having different structures from those of the foregoing exemplary embodiment will be illustrated and described in detail.

Referring to FIGS. 6A through 6F, in the present exemplary embodiment, the first and second internal connection conductors 123′ and 124′ may be formed in a non-linear manner, to the left and to the right in the thickness direction, rather than having a linear shape.

Also, within the ceramic body 110, the first internal connection conductor 123′, the first internal electrode 121, the second internal electrode 122, the first internal electrode 121, the second internal electrode 122, and the second internal connection conductor 124′ may be repeatedly disposed in this order, but the present inventive concept is not limited thereto and layout order of the first and second internal connection conductors 123′ and 124′ may be appropriately modified as necessary.

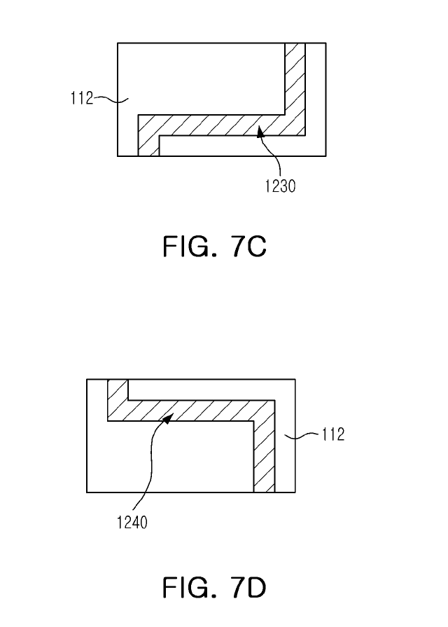

FIGS. 7A through 7D are plan views illustrating a layout structure of the first and second internal electrodes and the first and second internal connection conductors applied to an MLCC according to another exemplary embodiment of the present disclosure.

Here, the structure in which the ceramic body 110 and the first to fourth external electrodes 131, 132, 133, and 134 are formed is identical to that of the exemplary embodiment as described above, so a detailed description thereof will be omitted to avoid repetition, and first and second internal electrodes 1210 and 1220 and the first and second internal connection conductors 1230 and 140 having different structures from those of the foregoing exemplary embodiment will be illustrated and described in detail.

Referring to FIGS. 7A through 7D, in the present exemplary embodiment, a first lead portion 1210a of the first internal electrode 1210 is exposed to the first main surface 1 of the ceramic body 110 so as to be connected to the second external electrode 132, and in case of the second internal electrode 1220, a second lead portion 1220a is exposed to the second main surface 2 of the ceramic body 110 so as to be connected to the fourth external electrode 134 in the same manner as that of the exemplary embodiment as described above.

Also, the first internal connection conductor 1230 may be formed to have a ‘┘’ shape in the length and thickness directions of the ceramic body 110, and the second internal connection conductor 1240 may be formed to have a ‘┐’ shape in the length and thickness directions of the ceramic body 110.

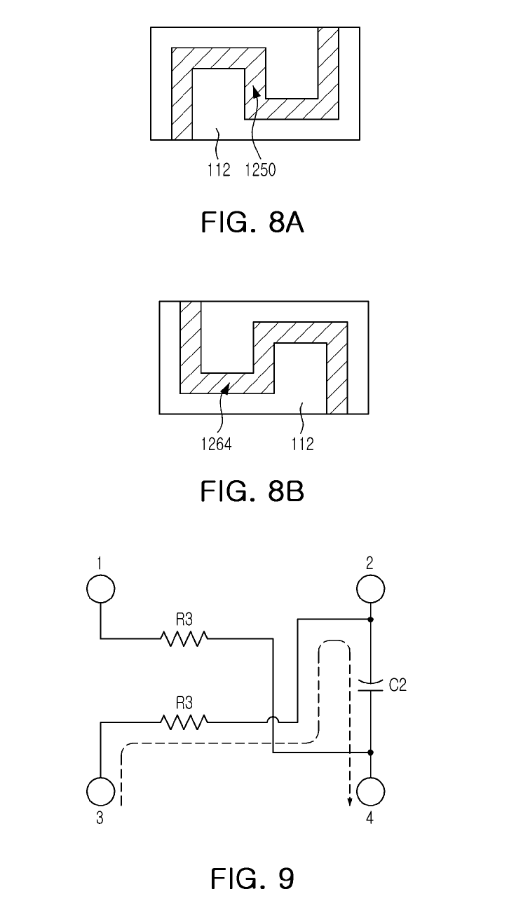

Referring to FIGS. 8A and 8B, in another exemplary embodiment, first and second internal connection conductors 1250 and 1260 may be formed in a non-linear manner, vertically in the length direction of the ceramic body 110.

FIG. 9 is an equivalent circuit diagram of the MLCC of FIGS. 7A through 8B.

Referring to FIG. 9, the first and second internal electrodes 1210 and 1220 constituting a capacitor unit may be connected in parallel by the first to fourth external electrodes 131, 132, 133, and 134, and may be connected in series to the first and second internal connection conductors 123 and 124 constituting an ESR layer.

Through the foregoing connections, the ESR of the MLCC 100 may be controlled by the first and second internal connection conductors 1230 and 1240.

As set forth above, according to exemplary embodiments of the present disclosure, ESR of the MLCC may be simply controlled by adjusting the shape and number of ESR control layers interposed within the ceramic body.

Thus, impedance may be easily reduced and controlled in a frequency region wider than that of the related art structure, and since components of the MLCC are reduced, when the MLCC is mounted on a PCB, a mounting space and cost may be reduced.

In addition, because the capacitor is mounted on a board to be perpendicular thereto, the downsizing of a product may not be hindered by the non-contact terminals, which may be advantageous for miniaturization of the product.

While exemplary embodiments have been shown and described above, it will be apparent to those skilled in the art that modifications and variations could be made without departing from the spirit and scope of the present disclosure as defined by the appended claims.

What is claimed is:

1. A multilayer ceramic capacitor comprising:
a ceramic body including a plurality of dielectric layers laminated in a width direction to be perpendicular to a mounting surface and having first and second main surfaces facing each other in a thickness direction, third and fourth end surfaces facing each other in a length direction, and fifth and sixth side surfaces facing each other in the width direction;
first and second external electrodes formed on the first main surface of the ceramic body to be spaced apart from each other;
third and fourth external electrodes formed on the second main surface of the ceramic body to be spaced apart from each other;
a capacitor unit including a plurality of first and second internal electrodes disposed to face each other with the dielectric layers interposed therebetween within the ceramic body and electrically connected to the first to fourth external electrodes; and
at least one equivalent serial resistance (ESR) control layer interposed within the ceramic body to be perpendicular to the mounting surface.

2. The multilayer ceramic capacitor of claim 1, wherein the first internal electrodes are exposed to the first main surface to be electrically connected to the first external electrode.

3. The multilayer ceramic capacitor of claim 1, wherein the second internal electrode are exposed to the second main surface to be electrically connected to the fourth external electrode.

4. The multilayer ceramic capacitor of claim 1, wherein the at least one ESR control layer has first and second internal connection conductors connecting the first and third external electrodes and the second and fourth external electrodes, respectively.

5. The multilayer ceramic capacitor of claim 1, wherein the mounting surface of the multilayer ceramic capacitor is the second main surface of the ceramic body.

6. The multilayer ceramic capacitor of claim 4, wherein the first and second internal connection conductors are formed to have a linear shape.

7. A multilayer ceramic capacitor comprising:
a ceramic body including a plurality of dielectric layers laminated in a width direction to be perpendicular to a mounting surface and having first and second main surfaces facing each other in a thickness direction, third and fourth end surfaces facing each other in a length direction, and fifth and sixth side surfaces facing each other in the width direction;
first and second external electrodes formed on the first main surface of the ceramic body to be spaced apart from each other;
third and fourth external electrodes formed on the second main surface of the ceramic body to be spaced apart from each other;
a capacitor unit including a plurality of first and second internal electrodes disposed to face each other with the dielectric layers interposed therebetween within the ceramic body and exposed to the first and second main surfaces so as to be electrically connected to the second and fourth external electrodes, respectively; and
at least one equivalent serial resistance (ESR) control layer interposed within the ceramic body in the width direction and having first and second internal connection conductors connecting the second and third external electrodes and the first and fourth external electrodes, respectively.

8. The multilayer ceramic capacitor of claim 7, wherein the mounting surface of the multilayer ceramic capacitor is the second main surface of the ceramic body.

9. The multilayer ceramic capacitor of claim 7, wherein the first internal connection conductor is formed in the length and thickness directions of the ceramic body, and the second internal connection conductor is formed in the length and thickness directions of the ceramic body.

10. The multilayer ceramic capacitor of claim 7, wherein the first and second internal connection conductors are formed in a non-linear manner, vertically, in the length direction of the ceramic body.
